(19) United States
(12) Patent Application Publication
(10) Pub. No.: US 2003/0179894 A1
(43) Pub. Date: Sep. 25, 2003

(54) Directional microphone hearing aid system

(75) Inventor: Oleg Saltykov, Fairlawn, NJ (US)

Correspondence Address: Elsa Keller, Intellectual Property Department, Siemens Corporation, 186 Wood Avenue South, Iselin, NJ, 08830, US

(73) Assignee: Siemens Hearing Instruments, Inc.

(21) Appl. No.: 10/178,579

(22) Filed: Jun. 24, 2002

Related U.S. Application Data
(60) Provisional application No. 60/366,414, filed on Mar. 21, 2002.

(51) Int. Cl. H04R 25/00; H04R 9/08; H04R 11/04; H04R 17/02; H04R 19/04; H04R 21/02

(52) U.S. Cl. 381/313; 381/322; 381/356

(57) ABSTRACT

A hearing aid device of the type having a first and second port for receiving sound to the device. The hearing aid device includes a switch assembly operable to switch between a first mode and a second mode of operation, such as directional and omni-directional. The device further includes a microphone component having a front chamber, a rear chamber, a front inlet, a rear inlet, and an extra inlet. In the first mode the front inlet receives sound channeled from the front port, the rear inlet is blocked, and the extra inlet receives sound channeled from the front port to allow sound pressure to excite the rear chamber. In the second mode the extra inlet is blocked, the rear inlet receives sound channeled from the second port, and the front inlet receives sound channeled from the front port.

This patent application claims priority to provisional application, serial No. 60/366,414, filed Mar. 21, 2002, entitled “A Directional Microphone Hearing Aid System.”

### BACKGROUND OF THE INVENTION

1. Field of the Invention

The invention relates to hearing aids, and more particularly to directional hearing aids.

2. Description of the Prior Art

Conventional hearing aids comprise a single omni-directional microphone that amplifies sounds substantially equal from all directions. It is often difficult for an omni-directional hearing aid wearer to distinguish between a speaker's voice and background noise. Directional hearing aids have therefore been developed that accentuate a speaker's voice over background noise.

Directional microphones, although suitable for isolating a speaker's voice, typically have signal-to-noise ratios less than that of omni-directional microphones. In environments with little background noise, an omni-directional microphone is more desirable for a wearer. Therefore, hearing aids have been developed that include both an omni-directional and directional microphone wherein a wearer switches between the two modes as desired.

Hearing aids containing both an omni-directional microphone and a first order directional microphone typically have lower sensitivity in the directional mode and are larger compared to hearing aids containing only an omni-directional microphone. These dual mode hearing aids generally have two separate microphone cartridges and a separate toggle switch. The total space occupied by these components limits their use to users with ears large enough to accommodate the devices. An unfortunate result is that children often cannot make use of these larger devices.

Directional mode performance can be further improved by a device containing an omni-directional microphone and a second order directional microphone. Such devices include three separate microphones, limiting further the number of people who can be fitted with the devices.

Users of dual-mode hearing aid devices usually notice a difference in audio signal quality between the directional and omni-directional modes due to the lower sensitivity of a directional microphone at low frequencies compared to that of the omni-directional microphone. As used herein, “low frequency” is a frequency of below approximately 1000 Hz.)

Accordingly, the hearing aid industry seeks reduced sized hearing aids with improved sensitivity having omni-directional and directional functionality.

### SUMMARY OF THE INVENTION

Embodiments of the invention include a hearing aid device of the type having a front port and rear port for receiving sound to the device. The hearing aid device includes a switch assembly operable to switch between a first mode and a second mode of operation, such as directional and omni-directional. The device further includes a microphone component having a front chamber, a rear chamber, a front inlet, a rear inlet, and an extra inlet. In the first mode the front inlet receives sound channeled from the front port, the rear inlet is blocked, and the extra inlet receives sound channeled from the front port to allow sound pressure to excite the rear chamber. In the second mode the extra inlet is blocked, the rear inlet receives sound channeled from the rear port, and the front inlet receives sound channeled from the front port.

### BRIEF DESCRIPTION OF THE DRAWINGS

The invention is best understood from the following detailed description when read with the accompanying drawings.

FIG. 1 depicts a cross-sectional view of a hearing aid according to an illustrative embodiment of the invention.

FIG. 2 depicts microphone component inlets according to an illustrative embodiment of the invention.

FIG. 3 depicts a second order hearing aid device according to an illustrative embodiment of the invention.

FIG. 4 depicts microphone component inlets for a second order hearing aid device according to an illustrative embodiment of the invention.

FIG. 5 depicts a hearing aid device according to a further illustrative embodiment of the invention.

### DETAILED DESCRITION OF THE INVENTION

The hearing aid device in accordance with an embodiment of the present invention includes a microphone component having directional and omni-directional functionality. Inlets into the microphone component are either open or closed to provide or block sound pressure to chambers of the microphone component. By regulating to which chambers sound pressure is channeled it is possible to have similar sensitivity at low frequencies in the omni-directional mode as compared to the directional mode. A switch assembly switches between the directional and omni-directional modes in conjunction with opening and closing the inlets.

The configuration of an illustrative embodiment of the inventive hearing aid will first be described, followed by a description of its operation.

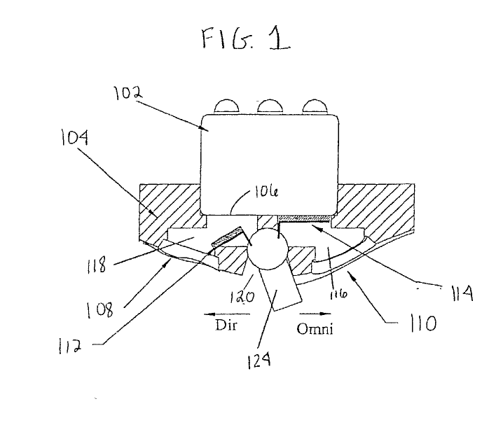

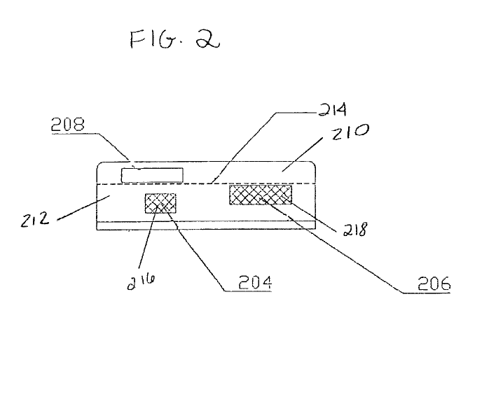

FIG. 1 depicts a cross-sectional view of a hearing aid device according to an illustrative embodiment of the invention. A microphone component 102 is at least partially embedded in a faceplate 104. In an exemplary embodiment, microphone component 102 is in cartridge form. Inlets to microphone component 102 are on a microphone component surface 106. (FIG. 2 provides further details of the inlets.) The illustrative example depicted in FIG. 1 has surface 106 perpendicular to the plane of the page. Surface 106, however, may be any surface of microphone component 102 on which inlets may be positioned.

A front port 108 and a rear port 110 are positioned in faceplate 104 to allow sound to travel to the microphone component inlets. (The terms “front” and “rear” are used herein to facilitate understanding of the invention because they are conventional terms. The terms, however, do not limit the invention to particular relative configurations.) The distance between the front and rear ports is preferably in a range of about 5 mm to about 12 mm

Valves 112 and 114 operate to open or block microphone component inlets to provide or block sound pressure to chambers of microphone component 102. Channels 116 and 118 extend between ports 108 and 110 and the microphone component inlets.

Switch assembly 120 includes a switch 124, a first valve 112 and a second valve 114 operable to open and block microphone inlets. Switch assembly 120 may be at least partially embedded in faceplate 104. Preferably switch 124 is a toggle switch.

FIG. 2 depicts an exemplary microphone component surface. The microphone component's front chamber 210 can be separated from the microphone's rear chamber 212 by a membrane 214. Membrane 214 may be of any material compatible with the functioning and fabrication of the microphone component. FIG. 2 depicts a front inlet 208, a rear inlet 206, and an extra inlet 204. Rear inlet 206 and/or extra inlet 204 preferably has an acoustic resistor, such as acoustic mesh, through which sound travels, depicted as cross-hatching in FIG. 2. The area of extra inlet 204 is preferably in a range of about 0.05 mm² to about 2.0 mm².

By viewing FIG. 2 in conjunction with FIG. 1, the operation of valves 112 and 114 with respect to inlets 206, 208 and 204 can be understood. In an exemplary embodiment, an omni-directional mode can be achieved by closing valve 114 to obstruct rear inlet 206, and opening valve 112 to allow sound to be channeled from front port 108 to extra inlet 204. Extra inlet 204 is also open to sound channeled from front port 108 in the omni-directional mode to provide more uniform sensitivity between the omni-directional and directional modes. As more uniform sensitivity between the modes is achieved, hearing comfort is typically improved.

To achieve a directional mode, valve 114 is open to allow sound to be channeled to rear inlet 206 from rear port 110, and valve 112 is closed, blocking extra inlet 204. Front inlet 208 also remains open to sound channeled from front port 108 in the directional mode.

Inlets 206, 208 and 204 are preferably located on the same face of the microphone component. Locating them on the same face of the assembly may be advantageous by reducing device size, and improving directionality, sensitivity and signal-to-noise ratio.

Sensitivity improvements resulting from the operation and configuration of the inventive hearing aid device are estimated to be in the range of about 1-4 dB.

Embodiments of the invention may be used for various types of hearing aid devices, for example, in the ear (ITE), in the canal (ITC), half shell (HS), and behind the ear (BTE) devices. Various circuit types may also be used with the inventive hearing aid device, including, for example, analog and digital circuits.

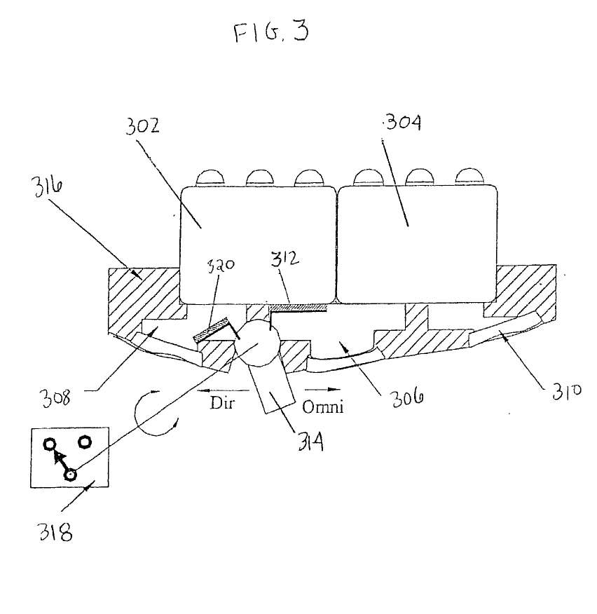

FIG. 3 depicts a hearing aid device with a second order directional/omni-directional microphone according to an illustrative embodiment of the invention. Two microphone components 302 and 304 are at least partially embedded in a faceplate 316, and may be configured to share a middle port 306. Microphone component 302 also utilizes port 308, while microphone component 304 utilizes port 310.

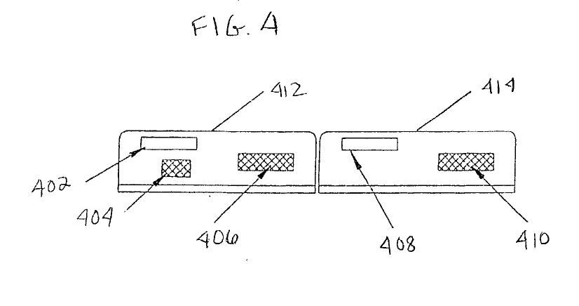

FIG. 4 depicts an illustrative embodiment of a second order directional hearing aid microphone component surface 400. The second order directional microphone includes two first order directional microphone components 412 and 414. Surface 400 contains a front inlet 402, an extra inlet 404 and a rear inlet 406, all to first order directional microphone component 412. Surface 400 further includes a front inlet 408 and a rear inlet 410, both to first order directional microphone component 414.

By viewing FIG. 3 in conjunction with FIG. 4, operation of the hearing aid device with the second order microphone may be understood. Switch 314 can be used to operate valves 312 and 320, thereby opening and blocking inlets 402 and 406. In a first mode, such as an omni-directional mode, only microphone component 302 is used. In the omni-directional mode, rear inlet 406 is blocked while inlets 402 and 404 are open. In the omni-directional mode, microphone component 304 is disconnected from an electronic circuit by electrical switch 318. Switching off second microphone 304 may be accomplished by a toggle switch 314 for example. In a second order, directional mode, both microphone components 302 and 304 convert a sound pressure signal into electrical signals, which can be processed by a special electronic circuit that includes a subtraction and a delay function.

A hearing aid device having a second order directional/omni-directional microphone configured as in FIG. 3 or having an equivalent configuration, will likely require less space compared to conventional devices that include three microphone components.

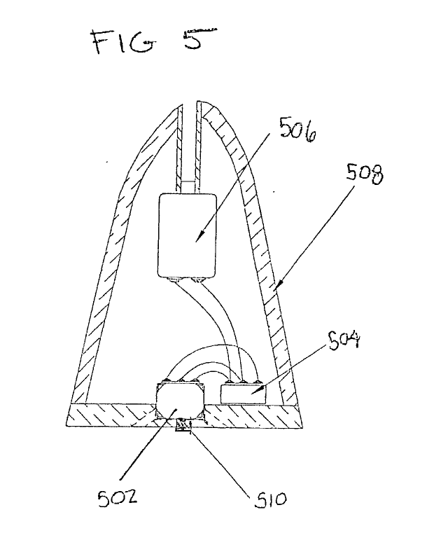

FIG. 5 depicts a hearing aid device according to a further embodiment of the invention. Microphone component 502 is operatively connected to a switch assembly 510, such as that depicted in FIG. 1 or 3 so that the microphone component can be switched between a first mode and a second mode. An electric circuit 504 is operatively connected to the microphone component. The electronic circuitry processes a signal from the microphone component representing the received sound. A receiver 506 is operatively connected to electric circuit 504. Microphone component 502 may be, for example, the kind depicted in FIG. 1 or 3. A housing 508 surrounds microphone component 502, electric circuit 504 and receiver 506. A faceplate, such as that depicted in FIG. 1 as part 104, may be mounted on housing 508 to accommodate microphone component 502. Housing 508 may be sized to fit within the ear of a hearing aid user. The housing may also be configured to be compatible with ITC, HS, and behind the ear BTE use.

While the invention has been described by illustrative embodiments, additional advantages and modifications will occur to those skilled in the art. Therefore, the invention in its broader aspects is not limited to specific details shown and described herein. Modifications, for example, to the layout of the hearing aid device components and their spacing, may be made without departing from the spirit and scope of the invention. Accordingly, it is intended that the invention not be limited to the specific illustrative embodiments, but be interpreted within the full spirit and scope of the appended claims and their equivalents.

1. A hearing aid device of the type having a front and rear port for receiving sound to the device, the hearing aid device comprising:
a switch assembly operable to switch between a first mode of operation and a second mode of operation; and
a microphone component having:
a front chamber;
a rear chamber;
a front inlet;
a rear inlet; and
an extra inlet; wherein
in the first mode the front inlet receives sound channeled from the front port, the rear inlet is blocked, and the extra inlet receives sound channeled from the front port to allow sound pressure to excite the rear chamber.
in the second mode the extra inlet is blocked, the rear inlet receives sound channeled from the rear port, and the front inlet receives sound channeled from the front port.

2. The hearing aid device of claim 1 wherein the front inlet, rear inlet and extra inlet are located on the same face of the microphone component.

3. The hearing aid device of claim 1 wherein the switch assembly comprises a toggle switch.

4. The hearing aid device of claim 1 wherein the switch assembly comprises:
a front valve operable to block the front inlet; and
a rear valve operable to block the extra inlet.

5. The hearing aid device of claim 1 wherein the microphone component is positioned at least partially within a faceplate

6. The hearing aid device of claim 1 wherein channels connecting the inlets to the ports are at least partially within the faceplate.

7. The hearing aid device of claim 6 wherein the channels connecting the inlets to the ports are completely within the faceplate.

8. The hearing aid device of claim 1 wherein the switch assembly is at least partially in the faceplate.

9. The hearing aid device of claim 1 wherein sound channeled through the extra inlet passes through an acoustic resistor.

10. The hearing aid device of claim 1 wherein sound channeled through the rear inlet passes through an acoustic resistor.

11. The hearing aid device of claim 1 wherein sound channeled through the extra inlet and the rear inlet passes an acoustic resistor.

12. The hearing aid device of claim 1 wherein the area of the extra inlet is a range of about 0.05 mm² to about 2 mm².

13. The hearing aid device of claim one wherein the distance between the front port and rear port is in a range of about 5 mm to about 12 mm.

14. The hearing aid device of claim 1 further comprising a second microphone component wherein the second microphone component is inactive in the second mode.

15. The hearing aid device of claim 1 further comprising a second microphone component wherein the first and second microphone components are activated in the first mode.

16. The hearing aid device of claim 1 further comprising a second microphone component wherein the first microphone component and second microphone component share a port.

17. The hearing aid device of claim 1 further comprising:
a housing for containing the microphone component;
electronic circuitry for processing a signal from the microphone component representing the received sound;
the housing having a faceplate mounted thereon; and
the housing being sized to fit within the ear of a hearing aid user and containing the microphone component.

18. A hearing aid device of the type having a front port and a rear port for receiving sound to the device, the hearing aid device comprising:
a switch assembly comprising a toggle switch operable to switch between a directional mode and an omni-directional mode; and
a microphone component positioned at least partially within the faceplate, the microphone component comprising:
a front chamber;
a rear chamber;
a front inlet;
a rear inlet; and
an extra inlet;
wherein the front inlet, rear inlet and extra inlet are located on the same face of the microphone component;
wherein in the omni-directional mode the front inlet receives sound channeled from the front port, and the extra inlet receives sound channeled from the front port to allow sound pressure to excite the rear chamber; and
wherein in the directional mode the extra inlet is blocked, the rear inlet receives sound channeled from the rear port, and the front inlet receives sound channeled from the front port.

19. The hearing aid device of claim 18 wherein the switch assembly comprises:
a front valve operable to block the front inlet; and
a rear valve operable to block the extra inlet.

20. The hearing aid device of claim 18 further comprising a second microphone component wherein the second microphone component is inactivated in the omni-directional mode.

21. The hearing aid device of claim 18 further comprising a second microphone wherein in the directional mode the first and second microphone components are activated.

22. The hearing aid device of claim 18 further comprising a second microphone component wherein the first microphone component and second microphone component share a port.

23. The hearing aid device of claim 18 further comprising:
a housing for containing the microphone component;
electronic circuitry for processing a signal from the microphone component representing the received sound;
the housing having a faceplate mounted thereon; and
the housing being sized to fit within the ear of a hearing aid user and containing the microphone component.

24. A hearing aid device of the type having a front port and a rear port for receiving sound to the device, the hearing aid device comprising:
a means for switching between an omni-directional mode of operation and a directional mode of operation;
a microphone means for amplifying sound in an omni-directional manner and a directional manner; and
a means for balancing sound pressure between chambers of the microphone means to reduce microphone means sensitivity at low frequencies in the omni-directional mode.

25. A processing method for use by a hearing aid device of the type having a front port and a rear port for receiving sound to the device, comprising the steps of:
switching between an omni-directional mode of operation and a directional mode of operation;
amplifying sound in an omni-directional manner and a directional manner; and
balancing sound pressure between chambers of the microphone means to reduce microphone means sensitivity at low frequencies in the omni-directional mode.
